(19) United States
(12) Patent Application Publication
(10) Pub. No.: US 2025/0249445 A1
(43) Pub. Date: Aug. 7, 2025

(54) METHOD AND SYSTEM FOR PRODUCTION OF PRODUCED WATER AND DESALINATION TREATMENT RESINS

(71) Applicant: SAUDI ARABIAN OIL COMPANY, Dhahran (SA)

(72) Inventors: Iaroslav Rybkin, Moscow (RU); Madina Baltaeva, Moscow (RU); Anton Manakhov, Ivanovo (RU); Maxim Orlov, Moscow (RU); Subhash C. Ayirala, Dhahran (SA)

(73) Assignees: SAUDI ARABIAN OIL COMPANY, Dhahran (SA); ARAMCO INNOVATIONS LLC, Moscow (RU)

(21) Appl. No.: 18/688,592

(22) PCT Filed: Feb. 1, 2024
(86) PCT No.: PCT/RU2024/000024

§ 371 Date: Mar. 1, 2024

(51) Int. Cl. B01J 41/04; B01J 41/14; B01J 47/02; C02F 1/42; C02F 103/08; C02F 103/10; C08F 8/06; C08F 8/36; C08J 9/26

(52) U.S. Cl. CPC B01J 41/04; B01J 41/14; B01J 47/02; C08F 8/06; C08F 8/36; C08J 9/26; C02F 1/42; C02F 2001/425; C02F 2103/08; C02F 2103/10; C08J 2201/0444; C08J 2205/044; C08J 2325/06

(57) ABSTRACT

An ion exchange resin includes a plurality of polymer resin particles which include a plurality of pores. The plurality of particles include an acid surface functionalization group and include a recycled thermoplastic polymer. A method for producing ion exchange resins includes dissolving a polymer and an emulsion stabilizer in a first solvent forming a dissolved polymer phase, mixing a removable matrix filler with the dissolved polymer phase to form a polymer mixture, forming an emulsion in a microfluidic device from the polymer mixture and a second solvent, precipitating a polymer composite which includes dispersed removable matrix fill in the microfluidic device, removing the dispersed removable matrix filler and forming precursor particles, and surface modifying the precursor particles, forming the ion exchange resin.

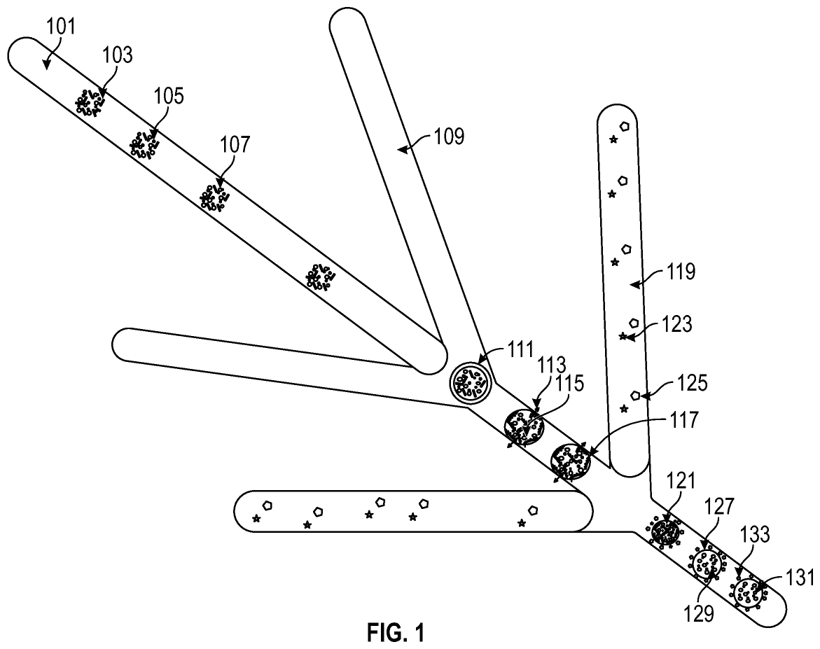

### BACKGROUND

The greatest volumetric by-product stream during oil and gas production is produced water. Dispersed oil, soluble and insoluble inorganic salts, heavy metals, suspended particles, and production-related compounds are the main environmentally hazardous constituents. These compounds are especially concerning because they pose a serious threat to the environment and human health when they are exposed to soil and water. Therefore, techniques are required to manage produce water waste, reduce accumulation of water waste, and clean the produced water. New development techniques must adhere to stringent standards set by increasing water quality regulations while also being commercially viable and environmentally beneficial.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an ion exchange resin which includes a plurality of polymer resin particles which include a plurality of pores. The plurality of particles include an acid surface functionalization group, and include a recycled thermoplastic polymer. The acid surface functionalization group includes functional groups selected from the group consisting of carboxylic acid, sulfonic acid, and phosphoric acid.

In another aspect, embodiments disclosed herein relate to a method for producing ion exchange resins, which includes dissolving a polymer and an emulsion stabilizer in a first solvent forming a dissolved polymer phase, mixing a removable matrix filler with the dissolved polymer phase to form a polymer mixture, forming an emulsion in a microfluidic device from the polymer mixture and a second solvent, precipitating a polymer composite which includes dispersed removable matrix fill in the microfluidic device, removing the dispersed removable matrix filler and forming precursor particles, and surface modifying the precursor particles, forming the ion exchange resin.

Other aspects and advantages of the claimed subject matter will be apparent from the following description and the appended claims.

### BRIEF DESCRIPTION OF DRAWINGS

The figure is a schematic depicting an ion exchange resin at various stages of formation in accordance with one or more embodiments of the present disclosure.

### DETAILED DESCRIPTION

One option for lowering production costs, enhancing product lifespan, and reducing environmental effect is waste recycling. Particularly, the high buildup of plastic waste necessitates immediate waste management while also creating several opportunities for utilizing recycled plastic in water purification systems. Polymers can be recycled into a useful matrix that, with the right surface treatment, can collect a variety of pollutants. The chemical structure of thermoplastics enables reuse of the polymer without losing any desirable properties of the material, making these materials a promising choice for creating water purification systems.

Ion-exchange resins are a conventional method for demineralizing saline water, allowing the removal of inorganic salts and enabling the potential reuse of produced water. This purified water can be used for various purposes such as waterflooding or frac-water injection, contributing to a circular water economy in line with a zero liquid discharge approach to produced water management.

An ion-exchange resin typically includes an insoluble support matrix with attached active groups, in the form of small porous beads. These active groups allow for ion exchange, trapping harmful ions and releasing non-harmful ones back into the liquid. The maximal removal efficiency of ion-exchange resins can be achieved by increasing the surface area and number of active groups, achieved through producing highly porous resins. Thus, sustainable production of these resins should focus on maximizing purification rates or ion removal efficiency by creating highly porous resins with active groups. Various fields, including medicine and biotechnology, have used microfluidics to create microcapsules containing medicine or other active compounds. Microfluidics may be used to produce tailored microbeads with an extremely tight size distribution, similar to microcapsules produced using the solvent extraction approach.

### Ion Exchange Resin

In one aspect, embodiments disclosed herein relate to an ion exchange resin that is useful for produced water and other water treatment applications. The ion exchange resin can also be used for purification of hypersaline wastewater discharge streams obtained from conventional seawater membrane-based desalination processes involving either reverse osmosis (RO) or nanofiltration (NF). The most useful system for produced water treatment includes a cation exchange resin to remove harmful components such as metals, soluble inorganic salts (containing calcium, magnesium, and other metals). Cation exchange resins may also remove organic contaminants, but the amount removed may depend on the properties of cation exchange resins and type of organic contaminants. The capacity of a typical weakly acidic cation exchange resin is 0.5 to 1.5 eq/L.

The ion exchange resins necessitate selection of removable matrix fillers, an emulsion stabilizer, a matrix polymer, a polymer solvent, a filler solubilizer, and surface modifiers for proper formation in the microfluidic process and performance in use. Selection of these components determines the ion exchange and thermomechanical performance of the ion exchange resins.

Removable matrix fillers are selected from the group of carbonate salts consisting of calcium carbonate, magnesium carbonate, barium carbonate, iron carbonate, copper carbonate, silver carbonate, zinc carbonate, lead carbonate, cobalt carbonate, nickel carbonate, ammonium carbonate, lithium carbonate, sodium carbonate, potassium carbonate, and combinations thereof.

Filler solubilizers are selected from the group consisting of acetic acid, acrylic acid, hydrochloric acid, hydrofluoric acid, hydrobromic acid, nitrous acid, nitric acid, hypochlorous acid, chlorous acid, chloric acid, perchloric acid, sulfurous acid, sulfuric acid, phosphorous acid, phosphoric acid, and combinations thereof.

The emulsion stabilizer is selected from the group of surfactants consisting of fatty acids, amino alcohols, fatty alcohols, fatty mercaptans, polyethylene glycol, polypropylene glycol, polyvinyl alcohol, polysorbates, fatty acid esters of sorbitol, fatty acid esters of glycerol, fatty acid esters of polyhydroxy compounds, alkylphenol ethoxylates, alkyl polyglucosides, fatty alcohol ethoxylates, ethoxylated amines and/or fatty acid amides, cetrimonium bromide, octenidine dihydrochloride, dioctadecyldimethylammonium bromide, cetylpyridinium chloride, benzalkonium chloride, benzethonium chloride, dimethyldioctadecylammonium chloride, ammonium lauryl sulfate, sodium lauryl sulfate, ammonium dodecyl sulfate, sodium dodecyl sulfate, sodium lauryl ether sulfate, sodium myreth sulfate, dioctyl sodium sulfosuccinate, perfluorobutanesulfonate, alkyl-aryl ether phosphates, alkyl ether phosphates, alkyl aryl sulfonates, alkyle benzene sulfonates, alkyl sulfates, N-ethoxy sulfonates, sodium dodecyl sulfates, alcohol propoxy sulfates, alkyl ethoxy sulfates, alpha-olefin sulfonates, alpha-olefin sulfates, branched alkyl benzene sulfonates, docusate sodium, ethoxy glycidyl sulfonates, propoxy glycidyl sulfonates, alkyl ether sulfates, internal olefin sulfonates, sulfonated ethoxylated alcohols, sulfonated ethoxylated alkyl phenols, sodium petroleum sulfonates, alkyl alcohol propoxylated sulfates, alkyl phenols, monoglycerides, diglycerides, guar gum, canola oil, lecithin, carrageenan, ammonium phosphatide, derivatives and mixtures thereof.

The polymer that will serve as the matrix of the ion exchange resin particles is selected from the group of thermoplastic waste polymers consisting of poly(methyl methacrylate), polymethacrylate, poly(lactic-co-glycolic acid), polyester, polyethylene terephthalate, poly(styrene-isoprene), polybromostyrene, polyethylene, polyphenylene oxide, polyether sulfone, acrylonitrile butadiene styrene, polycarbonate, polyhydroxyalkanoate, polyhydroxybutyrate, polylactic acid, polyurethane, polyvinyl chloride, a poly(methyl methacrylate) based copolymer, a polymethacrylate based copolymer, a poly(lactic-co-glycolic acid) based copolymer, a polyester based copolymer, a polyethylene terephthalate based copolymer, a polystyrene based copolymer, a poly(styrene-isoprene) based copolymer, a polybromostyrene based copolymer, a polyethylene based copolymer, a polyphenylene oxide based copolymer, a polyether sulfone based copolymer, an acrylonitrile butadiene styrene based copolymer, a polycarbonate based copolymer, a polyhydroxyalkanoate based copolymer, a polyhydroxybutyrate based copolymer, a polylactic acid based copolymer, a polyurethane based copolymer, a polyvinyl chloride based copolymer, styrene-acrylate copolymers, a polyamide, a polyamide based copolymer, a polyether, a polyether based copolymer, a polyimide, a polyimide based copolymer, a polyolefin, a polyolefin based copolymer, polypropylene-polyethylene copolymers, an ethylene-vinylacetate copolymer, a polyacrylic acid, a polyacrylic acid based copolymer, a polyacrylate, a polyacrylate based copolymer, propylene-acrylate copolymer, propylene-methacrylate copolymers, oxidized polypropylene, oxidized polyethylene, propylene-ethylene oxide copolymers, acrylonitrile-butadiene-styrene copolymers, and mixtures thereof.

The solvent used for dissolving the thermoplastic polymer is an organic solvent selected from the group consisting of alkanes (n-Octane, n-Dodecane, cyclohexane, methylcyclohexane), aromatic hydrocarbons (benzene, toluene, naphthalene, styrene, o-xylene, ethylbenzene, p-diethylbenzene), halohydrocarbons (dichloromethane, dichloroethane, chloroform, carbon tetrachloride, chlorobenzene, o-dichlorobenzene), ethers (tetrahydrofuran, a diethyl ether, a dibenzyl ether, 1,4-dioxane), ketones (acetone, butanone, cyclohexanone, diethyl ketone, acetophenone, methyl isobutyl ketone, methylisoamyl ketone, isophorone,), esters (methyl acetate, ethyl formate, propylene 1,2 carbonate, ethyl acytate, diethyl carbonate, diethyl sulfate, n-butyl acetate), nitrogen compounds (pyridine, morpholine, N,N-dimethylformamide, a an acetonitrile), alcohols (an ethanol, an isopropanol, a propanol, butanol, benzyl alcohol), and mixtures thereof.

Surface modifiers which may be included are selected from the group consisting of acetic anhydride, acetyl chloride, sulfuric acid, pyridine, AlCl₃, tetrasodiumiminodisuccinate, ethylenediaminetetraacetic acid, nitrilotriacetic acid, diethylenetriaminepentaacetic acid, hydroxyethylethylenediaminetriacetic acid, ethylenebis(oxyethylenenitrilo)tetraacetic acid, 1,2-diaminocyclohexanetetraacetic acid, triethylenetetraminehexaacetic acid, dipicolinic acid, and combinations thereof. While some possibilities are listed here, one with skill in the art will recognize that other similar catalyst and chelating agent compounds similar to those listed above are possible. In addition, light or other energy sources may be used to modify the surface.

The ion exchange resin may be formed into polymer resin particles with precisely controlled pore size distributions, as well as surface functionality. In one or more embodiments, the polymer resin particles may have a size ranging from a lower limit of one of 0.03, 0.04, 0.05, 0.06, and 0.07 mm to an upper limit of one of 2.6, 2.7, 28, 2.9, an 3.0 mm where any lower limit can be used in combination with any mathematically compatible upper limit.

In one or more embodiments the polymer resin particles may have a pore size ranging from a lower limit of one of 1, 2, 3, 4, and 5 nm to an upper limit of one of 250, 260, 270, 280, 290, and 300 microns where any lower limit can be used in combination with any mathematically compatible upper limit. A large range of pores sizes is expected since they are formed by gas generation.

In one or more embodiments, the ion exchange resin has an ion exchange capacity ranging from a lower limit of one of 0.25, 0.35, 0.45, and 0.55 eq/L to an upper limit of one of 1.2, 1.3, 1.4, and 1.5 eq/L where any lower limit can be used in combination with any mathematically compatible upper limit.

The resin can comprise a number of recycled thermoplastic materials that can be used to achieve required properties of the resin bead such as thermomechanical performance, chemical resistance, hydrophobicity, ion exchange capacity, and regeneration capabilities.

### Method for Producing Ion Exchange Resins

In one aspect, embodiments disclosed herein relate to a method for producing ion exchange resins. In one or more embodiments, the method allows for recycling thermoplastic polymers for use in microfluidic-based production of cation-exchange resins. The method includes dissolving a polymer and an emulsion stabilizer in a first solvent, forming a dissolved polymer phase; mixing a removable matrix filler with the dissolved polymer phase to form a polymer mixture, forming an emulsion in a microfluidic device from the polymer mixture and a second solvent; precipitating a polymer composite in the microfluidic device, wherein the polymer composite comprises dispersed removable matrix filler; removing the dispersed removable matrix filler and forming precursor particles; and surface modifying the precursor particles, forming the ion exchange resin. The method may further include loading the reins into filtration unit for purification.

In one or more embodiments, the resins are formed in a microfluidic device utilizing polymer precipitation. As understood by one skilled in the art, an emulsion is a fine dispersion of one liquid in another in which it is not soluble nor miscible. Emulsions produced by the method disclosed herein may include sub-micron emulsions, microemulsions, mini-emulsion, emulsions, and suspensions. An emulsion can be a discontinuous internal water phase in a continuous oil phase, forming water-in-oil emulsions (W/O), or can be a number of other possibilities including oil-in-water (O/W) emulsions. Also, the emulsion may be more complicated with the discontinuous phase itself being a dispersion, such as a water-in-oil-in-water (W/O/W) or oil-in-water-in-oil (O/W/O) type of emulsion. The precipitation of polymers in emulsions can occur in the water phase, the oil/solvent phase or the interphase between water and oil/solvent phases, more than one of the above phases or in all the above phases. Thus, the polymer precipitation includes the precipitation from emulsion, mini-emulsion, sub-micron emulsion, microemulsion, suspension, or colloid.

In one or more embodiments, thermoplastic waste polymers are collected and dissolved in a suitable solvent. The dissolved polymers are mixed with the removable filler to control the precipitation process and allow for pore formation after filler removal. The mixture is supplied into a microfluidic device to yield precisely sized precipitated resin beads. In one or more embodiments, during the precipitation, the filler can be removed to induce formation of pores on the surface of the resins. In one or more embodiments, the surface may also be functionalized during or after the filler removal. Once the resins are produced, they are suitable for monovalent and bivalent cation removal from produced water.

In one or more embodiments, the method includes dissolving a polymer and an emulsion stabilizer in a first solvent, forming a dissolved polymer phase. The dissolved polymer phase can be prepared using a mixture of dissolved recycled polymers to provide additional properties to the resins. After dissolving matrix polymers with a stabilizer, the matrix filler with specific size particle distribution is added to the mixture under constant mixing. The concentration of removable matrix filler may be in an amount ranging from a lower limit of any of 0, 1, 2, or 3% w/v to an upper limit of any of 8, 9, 10% w/v, where any lower limit can be used in combination with any mathematically compatible upper limit.

The removable matrix filler may include several fractions of particle sizes to provide the most suitable distribution of pores and their sizes within the final particle. In one or more embodiments, the removable matrix filler has a size ranging from a lower limit of one of 10, 11, 12, 13, 14, and 15 nm to an upper limit of one of 1, 1.1, 1.2, 1.3, and 1.4 mm where any lower limit can be used in combination with any mathematically compatible upper limit.

The use of matrix filler particles also ensures the formation of spherically shaped rigid particles in the polymer precipitation, which in some cases cannot be formed without such a material due to a low polymer density.

In one or more embodiments, the microfluidic device includes a microfluidic chip to produce precise droplets, a set of pumps to supply liquids to the microfluidic chip, and a collection area. Utilizing a microfluidic chip provides several advantages, including a high level of control over processing. For instance, the components to produce microcapsules may be fed through a temperature-controlled set of syringe pumps that allow for constant feeding into the microfluidic chip. In addition, each syringe pump may use a feed rate control unit for precise dosing. The ability to prepare and accurately dose multiple phases also allows for addition of specific components at desired points in the process and in variable orders. Each pump has a feed rate control unit for precise dosing and a mixer to maintain equal distribution of the removable matrix filler during pumping. Several pumps can be used to maintain a constant supply of components within the microfluidic chip. The collection area allows for collection of the resin particles.

In one or more embodiments, at least two phases are used to precipitate the polymer. The first phase may comprise a first solvent dissolving the polymer, and the second phase may comprise a second solvent. In one or more embodiments, the first phase is mixed with second solvent in a junction of a microfluidic chip, which precipitates the polymer. In some embodiments, three phases are used as they allow controllable polymer precipitation. In such embodiments, the polymer is dissolved in a first phase, which is emulsified with another non-polymer solving second phase and mixed with the third phase extracting both phases and inducing polymer precipitation. The phases are mixed at a junction of the microfluidic chip to precipitate the resin with removable filler particles distributed throughout the resin particle.

In one or more embodiments, the second solvent is selected from the group consisting of water, alcohols, and aliphatic hydrocarbons.

In one or more embodiments, the second phase, third phases, or both, comprise filler solubilizer and surface modifying compounds. In one or more embodiments, the filler solubilizers dissolve the removable matrix filler and release carbon dioxide that results in the formation of pore in the particles. In one or more embodiments, carbon dioxide generation is an energetic process, which contributes to producing pores in the polymer matrix. Initially, pore formation is controlled by solubilizing the removable matrix filler particles, leaving a cavity. Subsequently, generated gas expands the polymer matrix, resulting in the formation of additional pore space. The pore size is expected to be proportional to the particle filler size, the amount of filler, and its size distribution. Therefore, in one or more embodiments, it is possible to impart controllably sized pores with multi-modal distributions if the removable matrix filler particles chosen possess a multi-modal distribution of sizes.

In one or more embodiments, surface modifiers may be used to alter the surface chemistry of the resin particles. Both the surfaces of the internal pore structure and outer surfaces are modified. In one or more embodiments, the surface modifiers may react directly with the surface. In one or more embodiments, they may catalyze reactions between filler solubilizers and resin surfaces, which allows for the deposition of active groups useful in ion exchange. Chemical catalysts or light may be used to catalyze surface reactions. If the deposited groups are acetyl groups, they need to be additionally oxidized by base and halogens in an additional step. In one or more embodiments, acetic anhydride is used to modify the surface with carbonyl groups that are subsequently oxidized to produce carboxylic acid groups. By exposing the finished resin particle to the acetic anhydride, the carboxylic acid groups may only be present on the surface of the resin particle. In one or more embodiments, ion exchange resins are produced with attached sulfonic acid, phosphoric acid, and/or carboxylic acid functional groups to enable removal of cations from produced water.

In one or more embodiments, the produced resins are then collected and placed in filtration system for purification of produced water. The prepared resins should be washed to remove any residual chemicals from the reactions. Then, the resins are dried before being used in a purification process. The placement of resins in a filter for water purification depends on the type of filter and the desired treatment goals. However, the general process includes preparation of the filter including cleaning and drying, constructing the resin bed including putting layers of the resin within a filter, rinsing filter with clean water to remove any remaining loose particles or impurities, placing a filter cap on the filter housing, integration of assembled filtration unit into filtration system, and monitoring of water quality.

The figure, while not necessarily drawn to scale, is meant to conceptually demonstrate the process and the structure of the resin developed. The figure demonstrates the resin particles at various stages of production in a microfluidic device. A polymer 103 and emulsion stabilizer are dissolved in the first solvent to form a dissolved polymer phase 101. The dissolved polymer phase 101 also contains removable matrix filler particles of submicron to micron sizes 105 as well as contains removable matrix filler particles of micron to millimeter sizes 107, that are evenly distributed in the dissolved polymer phase 101, forming a polymer mixture. Mixing the dissolved polymer phase 101 with aqueous or oil miscible phases 109 results in the formation of unstable emulsions 111. The selection of 109 as either an aqueous or oil miscible depends on the solubility of the polymer in the dissolved polymer phase 101. When the dissolved polymer phase 101 is mixed with 109, the polymer 103 does not dissolve in 109, causing precipitation of the polymer 113, where the precipitating polymer 115 forms a polymer mesh 117, with removable matrix filler particles of submicron to micron sizes 105 and removable matrix filler particles of micron to millimeter sizes 107 incorporated in the precipitated structure.

Presence of the filler solubilizer in the second solvent, third solvent, or both causes the removable matrix filler particles of submicron to micron sizes 105 and removable matrix filler particles of micron to millimeter sizes 107 to be removed, forming pores 121 proportional to the particle diameter in precursor particles. Under exposure of solubilizer 119, removable matrix filler particles of submicron to micron sizes 105 and removable matrix filler particles of micron to millimeter sizes 107 form pores 121 proportional to the particle diameter At the same time in the microfluidic device, surface modifiers 123 surface modify the resin with active groups 125. Such surface modification can occur also without 123 if a stronger version of 119 is applied. The surface of polystyrene can be directly modified using strong acids such as sulfuric acid under appropriate concentration. Such modification may affect removal of matrix filler by inducing secondary precipitation of salts. Therefore, acetic-like acids (or nitric-like acids) need to be applied to dissolve removable filler. Sulfuric acid can also be used directly if removable matrix fillers do not induce salt precipitation such as sodium carbonate. In this way, the removable matrix filler creates the pores and does not influence the selection and use of surface modifiers.

As a result, the resin particles are fully precipitated as an ion-exchange resin bead 127 with small 129 and large 131, possessing precise pore distribution and the presence of functional groups 133 that allow ion-exchange.

### Examples

### Example 1

The polystyrene is dissolved in dimethylformamide (DMF) in concentration of 20% w/v and 0.5% v/v of emulsion stabilizer is added to the mixture. After complete dissolution of polystyrene, 2.5% w/v of submicron and 2.5% w/v of micron sized CaCO₃ particles are added to the mixture and well dispersed under constant stirring. The aqueous phase contains 10% v/v acetic anhydride in glacial acetic acid and pyridine as a catalyst. The prepared phases are then introduced to microfluidic chip for mixing and emulsion formation by a set of pumps. Once the phases are mixed in a channel junction, the droplets of dissolved polymer phase release the solvent (DMF) into aqueous phase and the polymer precipitates. Since the aqueous phase contains acids, it solubilizes the resin filler particles and pores proportional to the particle size (either sub- or micron sized pores) are produced. In addition, the polystyrene surface is acetylated through the binding of acetyl groups from the molecules of acetic anhydrides. These obtained acetyl groups must be further oxidized by base and halogens to produce carboxylic-based ion exchange resins. This oxidation can be done directly within the microfluidic chip by supplying formed resins and a base and halogen mixture to another junction, where they can react and/or ensure a proper level of oxidation. For example, halogens may include Cl₂, Br₂, and I₂, and bases may include potassium hydroxide and sodium hydroxide.

### Example 2

Polystyrene is dissolved in acetone in concentration of 10% w/v and 0.1% v/v of emulsion stabilizer is added to the mixture. After complete dissolution of polystyrene, 5% w/v of micron sized Na₂CO₃ particles are added to the mixture and dispersed thoroughly under constant stirring. The aqueous phase contains 20% v/v sulfuric acid. The prepared phases are then introduced to microfluidic chip for mixing and emulsion formation by a set of pumps. Once the phases are mixed in a channel junction, the droplets of oil phase release the acetone solvent into aqueous phase. As a result, the polymer precipitates. Since the aqueous phase contains sulfuric acid, the resin filler particles are solubilized, producing pores that are proportional to the particle size. The surface of polystyrene is also modified by the activity of sulfuric acid during the solubilization process, due to the concentration of sulfuric acid. Therefore, it results in the formation of ion-exchange resins with attached strongly acidic sulfonic groups.

Embodiments of the present disclosure may provide at least one of the following advantages. This method employs one stage production of ion-exchange resins, which can be more efficient and less costly than other multi-step methods utilizing microfluidics. Controllable formation of pores is achievable, as well as uniform size of resin beads. Using microfluidics for producing resins allows for precise size control of the final beads. This method allows for the introduction of removable filler and surface modification, with the microfluidic device allowing for precise control of the processing. Thermoplastic polymer recycling is an additional production benefit.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An ion exchange resin, the ion exchange resin comprising:
a plurality of polymer resin particles comprising a plurality of pores, wherein the plurality of particles and plurality of pores have an acid surface functionalization group, wherein the polymer resin particles comprise a recycled thermoplastic polymer, and wherein the acid surface functionalization group comprises functional groups selected from the group consisting of carboxylic acid, sulfonic acid, and phosphoric acid.

2. The ion exchange resin of claim 1, wherein polymer resin particle size is in the range of 0.3 to 3 mm.

3. The ion exchange resin of claim 1, wherein the plurality of pores are in the size range of 1 nm to 300 microns.

4. The ion exchange resin of claim 1, wherein ion exchange capacity is in the range of 0.25 to 1.5 eq/L.

5. A method for producing ion exchange resins, the method comprising:
dissolving a polymer and an emulsion stabilizer in a first solvent, forming a dissolved polymer phase;
mixing a removable matrix filler with the dissolved polymer phase to form a polymer mixture,
forming an emulsion in a microfluidic device from the polymer mixture and a second solvent;
precipitating a polymer composite in the microfluidic device, wherein the polymer composite comprises dispersed removable matrix filler;
removing the dispersed removable matrix filler and forming precursor particles; and
surface modifying the precursor particles, forming the ion exchange resin.

6. The method of claim 5, wherein the method further comprises loading the ion exchange resin into a filtration system for purification of produced water or other wastewater streams.

7. The method of claim 5, wherein the polymer is a recycled thermoplastic polymer.

8. The method of claim 5, wherein the first solvent is selected from the group consisting of alkanes, aromatic hydrocarbons, halohydrocarbons, ethers, ketones, esters, nitrogen-containing solvents, alcohols, and mixtures thereof.

9. The method of claim 5, wherein the emulsion stabilizer is a surfactant selected from the group consisting of fatty acids, amino alcohols, fatty alcohols, fatty mercaptans, fatty acid esters, fatty alcohol ethoxylates, phospholipids, anionic surfactants, fatty acid ethoxylates, fatty acid esters of sorbitol, alkylphenol ethoxylates, polyethylene glycols, polyvinyl alcohol, derivatives and mixtures thereof.

10. The method of claim 5, wherein the removable matrix filler is removed using a solubilizer, wherein the solubilizer is an acid selected from the group consisting of acetic acid, chloroacetic acid, acrylic acid, hydrochloric acid, hydrofluoric acid, hydrobromic acid, nitrous acid, nitric acid, hypochlorous acid, chlorous acid, chloric acid, perchloric acid, sulfurous acid, sulfuric acid, phosphorous acid, phosphoric acid, and mixtures thereof.

11. The method of claim 5, wherein the removable matrix filler is selected from the group consisting of calcium carbonate, magnesium carbonate, barium carbonate, iron carbonate, copper carbonate, silver carbonate, zinc carbonate, lead carbonate, cobalt carbonate, nickel carbonate, ammonium carbonate, lithium carbonate, sodium carbonate, potassium carbonate, and mixtures thereof.

12. The method of claim 5, wherein the removable matrix filler is in the size range of 10 nm to 1 mm.

13. The method of claim 5, wherein the wherein the second solvent is selected from the group consisting of water, alcohols, and aliphatic hydrocarbons.

14. The method of claim 5, further comprising inducing formation of a plurality of pores by removing the matrix filler.

15. The method of claim 5, wherein the emulsion is formed from three phases in the microfluidic device.

16. The method of claim 5, wherein the precipitating the polymer composite, the removing the dispersed removable matrix filler, and the surface modifying the precursor particles occur simultaneously.

17. The method of claim 5, wherein the surface modifying the precursor particles comprises exposing the precursor particle surface to a surface modifier in the microfluidic device, the surface modifier being selected from the group consisting of catalysts, acids, acid anhydrides, chelating agents, and combinations thereof.
